(19) United States
(12) Patent Application Publication
(10) Pub. No.: US 2001/0043993 A1
(43) Pub. Date: Nov. 22, 2001

(54) Slide-bead coating method and apparatus with coating liquid containing polyvinyl alcohol

(76) Inventor: Shotaro Ogawa, Fujinomiya-shi (JP)

Correspondence Address: Sughrue Mion Zinn, Macpeak & Seas, 2100 Pennsylvania Avenue N w, Washington, DC, 20037, US

(21) Appl. No.: 09/531,168

(22) Filed: Mar. 21, 2000

(30) Foreign Application Priority Data
Mar. 23, 1999 (JP) 11-078539

(51) Int. Cl. B05D 1/30; B05C 3/02

(52) U.S. Cl. 427/420; 118/410; 118/411; 427/294

(57) ABSTRACT

A running web is coated with a coating liquid containing polyvinyl alcohol by means of a slide hopper that has a slide surface of which the inclining angle with respect to a horizontal plane is within a range between 5° and 30°; a thickness T [mm] of the coating liquid on the running web is smaller than a thickness S [mm] of the coating liquid flowing down along the slide surface; a bead clearance CL [mm] between the end of the slide surface and the running web at the bead part is determined in accordance with the thickness T [mm] of the coating liquid on the running web in an inequality, T+0.05<CL<2T+0.1; and a bead back pressure P [mmH₂O] reduced at a bottom of the bead part with respect to an atmospheric pressure is determined in accordance with the bead clearance CL [mm] in an inequality, 2/CL+20<P<10/CL+20.

### BACKGROUND OF THE INVENTION

1. Field of the Invention

The present invention relates generally to a slide-bead coating method and apparatus with a coating liquid containing polyvinyl alcohol (PVA), and more particularly to a slide-bead coating method and apparatus with a PVA coating liquid for coating a continuously-running web with the PVA coating liquid to precisely form one or more layers on the web in the manufacture of heat sensitive recording paper, pressure-sensitive recording paper, printing plates, and the like.

2. Description of Related Art

A slide-hopper coating apparatus is an apparatus for coating a continuously-running web with a coating liquid, and it is used for coating the web with a coating liquid containing PVA (hereinafter referred to as a PVA coating liquid) with a uniform thickness without unevenness.

In a slide-bead coating method using the slide-hopper coating apparatus, the coating liquid flows down along a slide surface, and a bead part is formed at the gap between the end of the slide surface and the continuously-running web where the coating liquid meets the web. Then, the surface of the web is coated with the coating liquid through the bead part. Therefore, it is important to stabilize the bead part for stably coating the web.

The bead part is ordinarily stabilized by reducing the pressure at the bottom of the bead part (the reduced amount of the pressure with respect to the atmospheric pressure is hereinafter referred to as a bead back pressure). Air is involved in between the web and the bead part when the bead back pressure is too small, and streaks are formed in the running direction of the web when the bead back pressure is too large. Thus, the bead back pressure has to be appropriately adjusted.

When a coating speed (a running speed of the web) is high, however, the flow of the PVA coating liquids can not be stabilized even by adjusting the bead back pressure since the PVA coating liquids are rapidly expanded at the bead part. Especially, in the case that the web is coated with coating liquids such as the PVA coating liquids that contains a lot of high polymers at the high coating speed, the flow remarkably becomes unstable at the bead part due to the characteristics of the PVA coating liquids, and serious coating defects such as thickness unevenness, the air entrainment and the streaks occur.

Thus, the coating speed conventionally has to be 100 m/min or less in the slide-bead coating method with the PVA coating liquids, and the coating efficiency is low as a result. A slide-bead coating method where no coating defect occurs even when the coating speed is high is desired, and a variety of measures have been taken.

Japanese Patent Publication No. 3-39294 discloses that the viscosity of the bottom layer is low (within the range between 1 cP and 20 cP) and the bead clearance between the end of the slide surface and the running web at the bead part is within the range between 0.1 mm and 0.4 mm and the bead back pressure is within the range between 0 mmH₂O and 90 mmH₂O. Japanese Patent No. 2676289 discloses that the bead clearance is 0.1 mm or less and the inclining angle of the slide surface with respect to the horizontal plane is more than 0° and less than 15°. Japanese Patent No. 2736432 discloses that the meeting point where the coating liquid meet the web is above the center of a backup roller and the bead clearance is less than 0.2 mm and the inclining angle of the slide surface is more than 5° and less than 30°.

In the above-described conventional technics, however, the coating defects can not be prevented substantially enough when the coating speed is high at approximately 200 m/min or more.

### SUMMARY OF THE INVENTION

In view of the foregoing, it is an object of the present invention to provide a slide-bead coating method and apparatus with a PVA coating liquid, that can prevent coating defects (air entrainment and streaks) even when a coating speed is high.

To achieve the above-mentioned object, the present invention is directed to a slide-bead coating method where a slide-hopper coating apparatus makes a coating liquid containing polyvinyl alcohol flow down along a slide surface and coats a running web with the coating liquid through a bead part formed between an end of the slide surface and the running web, wherein: an inclining angle of the slide surface with respect to a horizontal plane is within a range between 5° and 30°; a thickness T [mm] of the coating liquid on the running web is smaller than a thickness S [mm] of the coating liquid flowing down along the slide surface; a bead clearance CL [mm] between the end of the slide surface and the running web at the bead part is determined in accordance with the thickness T [mm] of the coating liquid on the running web in an inequality (1), T+0.05<CL<2T+0.1; and a bead back pressure P [mmH₂O] reduced at a bottom of the bead part with respect to an atmospheric pressure is determined in accordance with the bead clearance CL [mm] in an inequality (2), 2/CL+20<P<10/CL+20.

To achieve the above-mentioned object, the present invention is also directed to a slide-bead coating apparatus, comprising: a slide hopper having a slide surface of which an inclining angle with respect to a horizontal plane is within a range between 5° and 30°, a coating liquid containing polyvinyl alcohol flowing down along the slide surface, the coating liquid being applied on a surface of a running web through a bead part formed between an end of the slide surface and the running web, a thickness T [mm] of the coating liquid on the running web being smaller than a thickness S [mm] of the coating liquid flowing down along the slide surface; a backing roller which supports the running web, the backing roller being arranged with respect to the slide hopper to form a bead clearance CL [mm] between the end of the slide surface and the running web at the bead part satisfying an inequality (1), T+0.05<CL<2T+0.1; and a pressure reduction device which reduces a bead back pressure P [mmH₂O] at a bottom of the bead part with respect to an atmospheric pressure satisfying an inequality (2), 2/CL+20<P<10/CL+20.

According to the present invention, air entrainment and streaks can be prevented even when a coating speed is high.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 is a structural drawing showing a slide-hopper coating apparatus with PVA coating liquids according to the present invention;

FIG. 2 is a conceptual drawing showing a bead part and its vicinity for setting appropriate conditions of a bead clearance CL and a bead back pressure P; and

FIG. 3 is a structural drawing in the case where corona discharge treatment is applied to a web.

### DETAILED DESCRIPTION OF THE PREFERRED EMBODIMENT

This invention will be described in further detail by way of example with reference to the accompanying drawings.

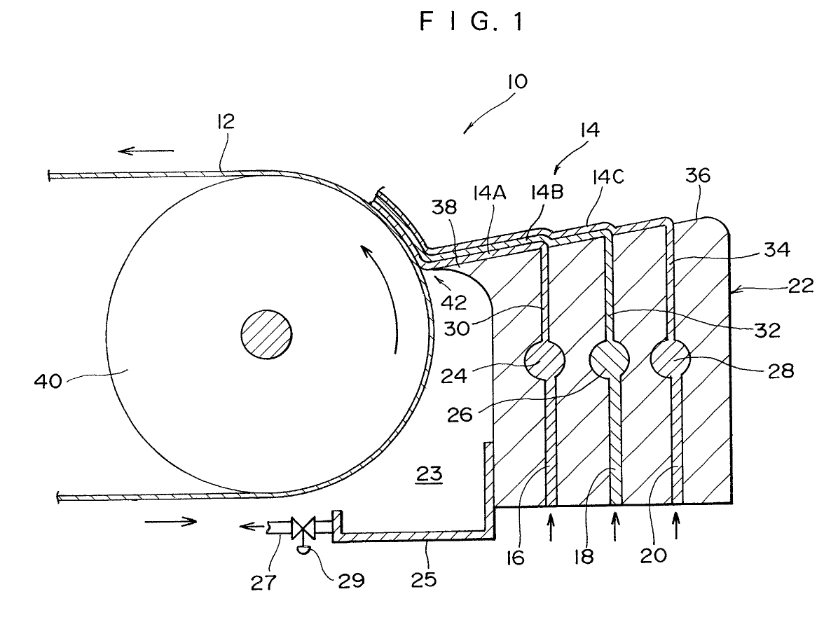

FIG. 1 is an explanation drawing showing the structure of a slide-hopper coating apparatus 10 to which a slide-bead coating method according to the present invention is applied, and three layers are simultaneously formed on a web 12.

As shown in FIG. 1, multiple types (e.g., three types) of coating liquids 14 to be applied on the surface of the web 12 are supplied to manifolds 24, 26, 28 in a slide hopper 22 through supply lines 16, 18, 20, respectively. The PVA coating liquids 14 supplied to the manifolds 24, 26, 28 are expanded in a coating width direction, and then they flow onto an inclined slide surface 36 through slit-shaped slots 30, 32, 34, respectively. The inclining angle α of the slide surface 36 with respect to the horizontal plane 39 is determined in accordance with the characteristics of the PVA coating liquids 14, a coating speed and the like, and is preferably within the range between 5° and 30°. The PVA coating liquids 14 flowing on the slide surface 36 form multiple layers without mixing with one another to flow along the slide surface 36, and reach a lip end 38 that is the bottom end of the slide surface 36. The PVA coating liquids 14 that reach the lip end 38 form a bead part 42 at the clearance between the lip end 38 and the surface of the web 12 running while being wound on a backing roller 40. A pressure-reduction box 25 is provided below the bead part 42 in such a manner as to enclose a space 23 between the web 12 and the slide hopper 22, and the pressure-reduction box 25 is connected to a vacuum device (not shown) through a pipe 27 on which a valve 29 for adjusting the pressure reduction of the space 23 in the pressure-reduction box 25 is provided. The bead part 42 is stabilized by raising the degree of vacuum in the space 23 to reduce the pressure at the bottom of the bead part 42 (the reduced amount of the pressure with respect to the atmospheric pressure is hereinafter referred to as a bead back pressure P). At the bead part 42, the web 12 runs upward along the surface of the backing roller 40. Thus, the PVA coating liquids 14 are pulled onto the surface of the web 12 and expanded to become thinner. Consequently, the thin multiple layers are formed on the surface of the running web 12. The thickness of the multiple layers depends on the running speed of the web 12. In FIG. 1, the reference numeral 14A denotes the PVA coating liquid that forms the bottom layer of the multiple layers, and the reference numeral 14B denotes the PVA coating liquid that forms the middle layer, and the reference numeral 14C denotes the PVA coating liquid that forms the top layer.

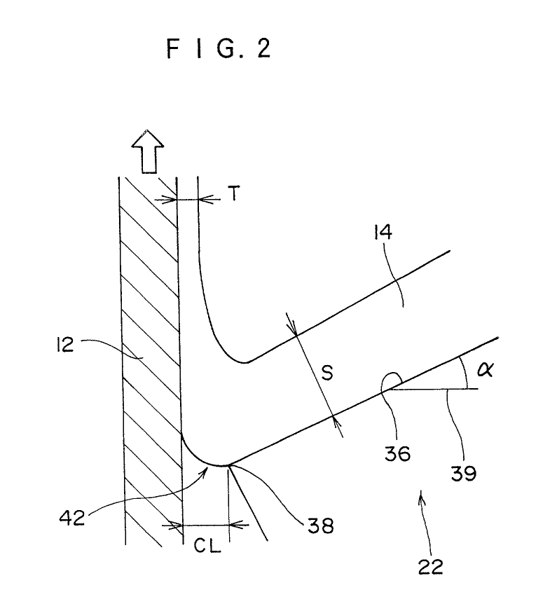

In the case of slide-bead coating with the PVA coating liquids 14, which contain PVA, however, the flow of the PVA coating liquids 14 becomes unstable due to the characteristics of the PVA coating liquids 14 since the PVA coating liquids 14 are rapidly expanded at the bead part 42 when the coating speed is high. As shown in FIG. 2, a bridge part of the bead part 42 between the web 12 and the lip 38 tends to become unstable, and a bead clearance CL between the lip 38 and the web 12 has a large effect on the stable coating with the PVA coating liquids 14. The PVA coating liquids 14 are rapidly accelerated at the bridge part to make the stable coating impossible when the bead clearance CL is too small, and the coating is impossible when the bead clearance CL is too large. Also, it is important to appropriately adjust the bead back pressure P for the stable coating. If the bead clearance CL and the bead back pressure P for the stable coating are not appropriately adjusted, coating defects (streaks in the running direction of the web 12 and air entrainment) occur in the multiple layers on the surface of the web 12 or the coating is impossible.

The present inventor has found out appropriate conditions of the bead clearance CL and the bead back pressure P where the coating defects do not occur even if the coating speed is high at approximately 200 m/min or more, as shown in FIG. 2.

(1) When the web 12 is coated with the PVA coating liquids 14 by means of the slide hopper 22 that has the slide surface 36 of which the inclining angle α is within the range between 5° and 30° with respect to the horizontal plane 39 in such a manner that a thickness T [mm] of the formed layers on the web 12 can be smaller than a thickness S [mm] of the PVA coating liquids 14 flowing down along the slide surface 36, the bead clearance CL [mm] is set in accordance with the thickness T [mm] of the formed layers in such a manner as to satisfy the following inequality (1):

T+0.05<CL<2T+0.1. (1)

(2) The bead back pressure P [mmH₂O] is set in accordance with the bead clearance CL [mm] in such a manner as to satisfy the following inequality (2):

2/CL+20<P<10/CL+20. (2)

Therefore, the larger the thickness T of the formed layers is, the larger the bead clearance CL has to be and the smaller the bead back pressure P has to be; and the smaller the thickness T of the formed layers is, the smaller the bead clearance CL has to be and the larger the bead back pressure P has to be.

The present invention determines the bead clearance CL and the bead back pressure P in the slide-bead coating method and the apparatus with the PVA coating liquids according to the above-described conditions. In the slide-bead coating method and the apparatus with the PVA coating liquids, the web 12 is coated with the PVA coating liquids 14 by means of the slide hopper 22 that has the slide surface 36 of which the inclining angle a is within the range between 5° and 30° with respect to the horizontal plane 39 in such a manner that the thickness T [mm] of the formed layers on the web 12 can be smaller than the thickness S [mm] of the PVA coating liquids 14 flowing down along the slide surface 36, then the bead clearance CL [mm] is set in accordance with the thickness T [mm] of the formed layers in such a manner as to satisfy the inequality (1) and the bead back pressure P [mmH₂O] is set in accordance with the bead clearance CL [mm] in such a manner as to satisfy the inequality (2).

The reason why the inclining angle α of the slide surface 36 is within the range between 5° and 30° with respect to the horizontal plane 39 is that the flowing speed of the PVA coating liquids 14 flowing down along the slide surface 36 is too high and the stable coating is impossible when the inclining angle α is more than 30°. Meanwhile, when the inclining angle α is less than 5°, the flowing speed of the PVA coating liquids 14 flowing down along the slide surface 36 is too low and the acceleration at the bead part 42 is too high, and thus the stable coating is impossible. The present invention deals with conditions where the running speed of the web 12 is higher than the flowing speed of the PVA coating liquids 14 flowing down along the slide surface 36, and therefore the thickness T [mm] of the formed layers on the web 12 is smaller than the thickness S [mm] of the PVA coating liquids 14 flowing down along the slide surface 36.

According to the present invention, the web 12 can be coated with the PVA coating liquids 14 without the coating defects even at the high speed coating.

The above-described conditions of the bead clearance CL and the bead back pressure P can be applied to both the single-layer coating and the multi-layer coating. In the three-layer coating in the present embodiment, it is preferable to satisfy the following conditions of the multi-layer coating as well as the above-described conditions.

(3) A relation has to be appropriately determined between the viscosities of the PVA coating liquid 14A that forms the bottom layer and the PVA coating liquid 14B that forms the middle layer. That is, the viscosity of the PVA coating liquid 14B that forms the middle layer is higher than the viscosity of the PVA coating liquid 14A that forms the bottom layer, so that the streak-shaped unevenness can be prevented.

(4) However, if the density of PVA contained in the PVA coating liquid 14A that forms the bottom layer is too high, the coating defects occur even if the viscosity of the PVA coating liquid 14A that forms the bottom layer is smaller than the viscosities of the PVA coating liquids 14B and 14C that form the middle and the top layers. To prevent the coating defects, the density of PVA contained in the PVA coating liquid 14A is within the range between 0.5% and 5%. The polymerization degree of PVA contained in the PVA coating liquid 14A that forms the bottom layer is within the range between 1000 and 4000, preferably within the range between 1500 and 3000.

Moreover, it is preferable to satisfy the following conditions when an additive used to increase viscosity is added to the PVA coating liquids 14. (5) It is important to determine the adding amount of the additive used to increase viscosity to the PVA coating liquid 14A that forms the bottom layer not in accordance with the amount of the PVA coating liquids 14 but the amount of PVA contained in the PVA coating liquids 14 for the stable high speed coating. The adding amount of the additive used to increase viscosity is within the range between 0.05% and 0.5% by weight with respect to PVA contained in the PVA coating liquids 14, preferably within the range between 0.06% and 0.4% by weight, more preferably within the range between 0.1% and 0.35% by weight. The effect of the added additive used to increase viscosity is small if the adding amount of the additive used to increase viscosity is less than 0.05% by weight, and the viscosity of the PVA coating liquids 14 becomes to high to cause the coating defects if the adding amount of the additive used to increase viscosity is more than 0.5% by weight.

(6) The polymerization degree of PVA is also important to make the added additive used to increase viscosity effective. The polymerization degree of PVA is within the range between 1000 and 4000, preferably within the range between 1500 and 3000. The rise in the viscosity by the additive used to increase viscosity is small and the effect of the added additive used to increase viscosity is small when the polymerization degree of PVA is less than 1000, and it is difficult to dissolve PVA and it is not suitable for practical use when the polymerization degree of PVA is more than 4000.

PVA used in the present invention is polyvinyl alcohol polymer. PVA is used as a binder in the case of chemical coating, and is used for maintaining barrier and surface strength, and the like. PVA is generated by saponifying vinylester such as vinyl acetate or vinylester that is generated by polymerizing in a polymerizing method such as bulk polymerization, emulsion polymerization, solution polymerization and suspension polymerization or copolymerizing vinylester with copolymerized monomer. The saponification rate of PVA is within the range between 60% and 100%, preferably within the range between 70% and 99.5%, more preferably within the range between 80% and 99.5%.

The additive used to increase viscosity may be water soluble cellulose compound, marine algae polysaccharide, carboxymethyl starch or the like, preferably water soluble cellulose compound.

The web 12 used in the present invention may be made of paper, resin film such as polyethylene film, metal foil, or the like.

In the present invention, surface treatment that is corona treatment or electrification treatment is applied to the web 12 just before the surface of the web 12 is coated with the PVA coating liquids 14.

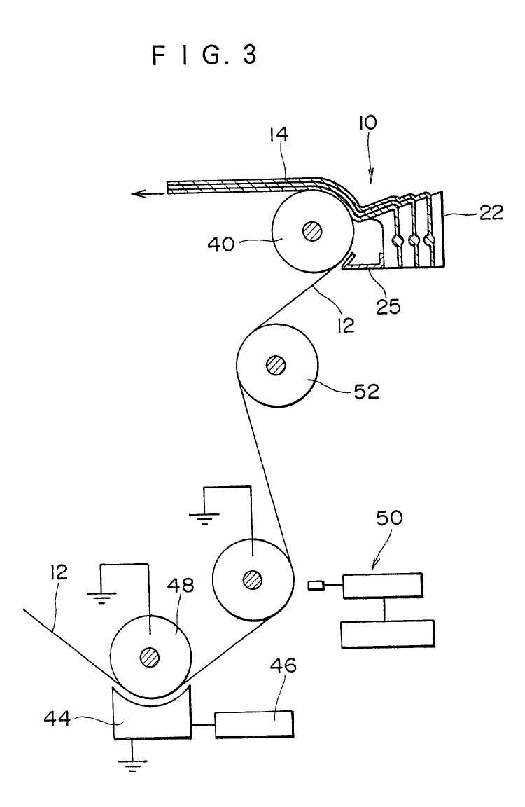

FIG. 3 is a structural drawing in the case where corona discharge treatment is applied to the web 12. As shown in FIG. 3, a high voltage is applied from a high-voltage power supply 46 to a web electrification apparatus 44 provided before the slide-hopper coating apparatus 10, and corona discharge is applied to the web 12 that runs while being wound on a grounded support roller 48. Thus, a single-pole electric charge is given to the surface of the web 12. Then, the web 12 passes a surface-potential meter 50, which measures the potential of the surface of the web 12 and records the potential in a recorder. The web 12 that has passed the surface-potential meter 50 reaches the backing roller 40 of the slide-hopper coating apparatus 10 through a pass roller 52, and is coated with the PVA coating liquids 14 from the slide hopper 22. As described above, the single-pole electric charge is given to the surface of the web 12 at the web electrification apparatus 44, so that the affinity and the adhesion of the web 12 and the PVA coating liquids 14 can be improved to improve the coating efficiency.

### EXAMPLES

The explanation will now be given of examples and comparative examples where two layers were simultaneously formed on the web 12 on the conditions in Table 1 by means of the slide-hopper coating apparatus described in the embodiment.

Examples (1)-(3) satisfied the conditions of the slide-bead coating method according to the present invention, while comparative examples (1)-(6) did not satisfy the conditions. The types of the PVA coating liquids that form the bottom and the top layers, the thicknesses T [mm] of the formed layers on the web (thicknesses T [mm] of wet layers on the web in Table 2), the bead clearances CL [mm] and the bead back pressures P [mmH₂O] are shown in Table 2.

In the examples (1)-(3) and the comparative examples (1)-(6), the additive used to increase viscosity was not added to the PVA coating liquids to eliminate the factors that affect whether the coating defects occur other than the bead clearance CL and the bead back pressure P. The web was intentionally coated on conditions where the viscosity of the PVA coating liquid forming the bottom layer was higher than the viscosity of the PVA coating liquid forming the top layer. The surface treatment was not applied to the web 12.

With respect to the examples (1)-(3) and the comparative examples (1)-(6), limit speeds at which coating defects started to occur were examined when only the coating speed were raised on the same coating temperature, the same operation conditions and the same web condition. Also, whether the coatings were possible or impossible was examined regardless of whether the coating defects occurred or not. In addition, which of the coating defects, streaks or air entrainment, occurred at the limit speeds were examined.

TABLE 1

| Items | Coating conditions |
|---|---|
| Coating | 40° C. (temperatures of PVA coating liquids are the same) |
| temperature | |
| Operation | Slide angle 15° |
| conditions | Web angle 75° |
| Web | PET film with thickness of 0.1 mm |
| Types of | (a) Solution containing water soluble PVA, heat sensitizing |
| coating | agent and pigment (density of solids is 8% by weight, |
| liquids | viscosity is 60 cP) |
| | (b) Solution containing water soluble PVA, heat sensitizing |
| | agent and pigment (density of solids is 6% by weight, |
| | viscosity is 40 cP) |
| | (c) Solution containing water soluble gelatin, heat |
| | sensitizing agent and pigment (density of solids is |
| | 8% by weight, viscosity is 60 cP) |
| | (d) Solution containing water soluble gelatin, heat |
| | sensitizing agent and pigment (density of solids is |
| | 6% by weight, viscosity is 40 cP) |

Notes in Table 1:
(i) The slide angle is the inclining angle of the slide surface with respect to the horizontal plane.
(ii) The web angle was the angle of the web with respect to the slide surface at the bead part.
(iii) The viscosity was the value when the shearing speed was 50 (1/sec).

TABLE 2

| | | | Thickness | | | Limit | | |
|---|---|---|---|---|---|---|---|---|
| | Type of | Type | T [mm] of | Bead | Bead back | coating | | |
| | bottom | of top | wet layers | clearance | pressure P | speed | Coating defect | Coating |
| | layer | layer | on web | CL [mm] | [mmH₂O] | [m/min] | at limit speed | possibility |
| Ex. (1) | (a) | (b) | 0.05 | 0.15 | 40-70 | 240 | Air | Possible |
| | | | | | | | entrainment | |
| Ex. (2) | (a) | (b) | 0.10 | 0.25 | 30-60 | 280 | Air | Possible |
| | | | | | | | entrainment | |
| Ex. (3) | (a) | (b) | 0.16 | 0.30 | 20-40 | 300 | Air | Possible |
| | | | | | | | entrainment | |
| Comp. | (a) | (b) | 0.10 | 0.12 | 20-40 | 160 | Air | Possible |
| Ex. (1) | | | | | | | entrainment | |
| Comp. | (a) | (b) | 0.10 | 0.30 | 20-60 | — | — | Impossible |
| Ex. (2) | | | | | | | | |
| Comp. | (a) | (b) | 0.10 | 0.25 | 20-28 | 140 | Air | Possible |
| Ex. (3) | | | | | | | entrainment | |
| Comp. | (a) | (b) | 0.10 | 0.25 | 60-80 | 120 | Streak-shaped | Possible |
| Ex. (4) | | | | | | | unevenness | |
| Comp. | (c) | (d) | 0.10 | 0.12 | 50-60 | 220 | Air | Possible |
| Ex. (5) | | | | | | | entrainment | |
| Comp. | (c) | (d) | 0.10 | 0.25 | 40-60 | 160 | Air | Possible |
| Ex. (6) | | | | | | | entrainment | |

As shown in Table 2, the limit speed of the comparative example (1) was 160 m/min at which the air entrainment started to occur, since the bead clearance CL was too small with respect to the thickness T of the formed layers and the inequality (1) was not satisfied. Meanwhile, in the comparative example (2), the coating was impossible since the bead clearance CL was too large with respect to the thickness T of the formed layers and the inequality (1) was not satisfied. The limit speed of the comparative example (3) was 140 m/min at which the air entrainment started to occur, since the bead back pressure P was too small with respect to the bead clearance CL and the inequality (2) was not satisfied though the inequality (1) was satisfied. On the other hand, the limit speed of the comparative example (4) was 120 m/min at which the streak-shaped unevenness started to occur, since the bead back pressure P was too large with respect to the bead clearance CL and the inequality (2) was not satisfied though the inequality (1) was satisfied.

The limit speeds of the examples (1)-(3), which satisfied the conditions of the slide-bead coating method according to the present invention, were within the range of 240 m/min and 300 m/min, thus the coating defects did not occur when the limit speeds were more than 200 m/min.

The examples according to the present invention restrained streaks and air entrainment compared with the comparative examples, and the limit speeds, at which the coating defects started to occur, of the examples were much larger than those of the comparative examples.

In the comparative examples (5) and (6), the bead clearances CL and the bead back pressures P were measured in the cases where the gelatin solutions were used as the coating liquids in stead of the PVA coating liquids. The limit speed of the comparative example (5) was 220 m/min, relatively high, though the bead clearance CL was a little smaller than the lower limit of the inequality 1 with respect to the thickness T of the formed layers. On the other hand, the limit speed of the comparative example (6) was 160 m/min, lower than that of the comparative example (5), though the inequality 1 was satisfied. When the gelatin solutions were used as the coating liquids, the limit speed was high in the case where the bead clearance CL was smaller than those of the examples where the PVA coating liquids were used. Thus, the bead clearance CL has to be appropriately adjusted according to the kind of the coating liquids.

As set forth hereinabove, according to the slide-bead coating method and apparatus with the PVA coating liquids of the present invention, the coating is possible and the coating defects (the streaks and the air entrainment) can be prevented even when the coating speed is high. The coating is possible and the coating defects do not occur even when the coating speed is 200 m/min or more in the slide-bead coating method of the present invention, while the conventional coating speed is approximately 100 m/min.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A slide-bead coating method where a slide-hopper coating apparatus makes a coating liquid containing polyvinyl alcohol flow down along a slide surface and coats a running web with the coating liquid through a bead part formed between an end of the slide surface and the running web, wherein:
an inclining angle of the slide surface with respect to a horizontal plane is within a range between 5° and 30°;
a thickness T [mm] of the coating liquid on the running web is smaller than a thickness S [mm] of the coating liquid flowing down along the slide surface;
a bead clearance CL [mm] between the end of the slide surface and the running web at the bead part is determined in accordance with the thickness T [mm] of the coating liquid on the running web in an inequality (1),
T+0.05<CL<2T+0.1;
and
a bead back pressure P [mmH₂O] reduced at a bottom of the bead part with respect to an atmospheric pressure is determined in accordance with the bead clearance CL [mm] in an inequality (2),
2/CL+20<P<10/CL+20.

2. The slide-bead coating method as defined in claim 1, wherein a coating speed that is a running speed of the running web is within a range between 100 m/min and 300 m/min.

3. The slide-bead coating method as defined in claim 1, wherein surface treatment by one of corona treatment and electrification treatment is applied to the running web before the surface of the running web is coated with the coating liquid.

4. A slide-bead coating method where a slide-hopper coating apparatus makes a plurality of coating liquids containing polyvinyl alcohol flow down along a slide surface and coats a running web with the coating liquids through a bead part formed between an end of the slide surface and the running web to simultaneously form a plurality of layers on a surface of the running web, wherein:
an inclining angle of the slide surface with respect to a horizontal plane is within a range between 5° and 30°;
a total thickness T [mm] of the coating liquids on the running web is smaller than a total thickness S [mm] of the coating liquids flowing down along the slide surface;
a bead clearance CL [mm] between the end of the slide surface and the running web at the bead part is determined in accordance with the total thickness T [mm] of the coating liquids on the running web in an inequality (1),
T+0.05<CL<2T+0.1;
and
a bead back pressure P [mmH₂O] reduced at a bottom of the bead part with respect to an atmospheric pressure is determined in accordance with the bead clearance CL [mm] in an inequality (2),
2/CL+20<P<10/CL+20.

5. The slide-bead coating method as defined in claim 4, wherein a density of polyvinyl alcohol contained in one of the coating liquids that forms a bottom layer among the layers is within a range between 0.5% and 5% by weight.

6. The slide-bead coating method as defined in claim 5, wherein a viscosity of at least one of the coating liquids that forms one of the layers other than the bottom layer is higher than a viscosity of the one of the coating liquids that forms the bottom layer.

7. The slide-bead coating method as defined in claim 4, wherein a coating speed that is a running speed of the running web is within a range between 100 m/min and 300 m/min.

8. The slide-bead coating method as defined in claim 4, wherein surface treatment by one of corona treatment and electrification treatment is applied to the running web before the surface of the running web is coated with the coating liquids.

9. A slide-bead coating apparatus, comprising:
a slide hopper having a slide surface of which an inclining angle with respect to a horizontal plane is within a range between 5° and 30°, a coating liquid containing polyvinyl alcohol flowing down along the slide surface, the coating liquid being applied on a surface of a running web through a bead part formed between an end of the slide surface and the running web, a thickness T [mm] of the coating liquid on the running web being smaller than a thickness S [mm] of the coating liquid flowing down along the slide surface;
a backing roller which supports the running web, the backing roller being arranged with respect to the slide hopper to form a bead clearance CL [mm] between the end of the slide surface and the running web at the bead part satisfying an inequality (1),
T+0.05<CL<2T+0.1;
and
a pressure reduction device which reduces a bead back pressure P [mmH₂O] at a bottom of the bead part with respect to an atmospheric pressure satisfying an inequality (2),
2/CL+20<P<10/CL+20.

10. The slide-bead coating apparatus as defined in claim 9, wherein a coating speed that is a running speed of the running web is within a range between 100 m/min and 300 m/min.

11. The slide-bead coating apparatus as defined in claim 9, further comprising a surface treatment apparatus which applies surface treatment to the running web by one of corona treatment and electrification treatment before the surface of the running web is coated with the coating liquid.

12. A slide-bead coating apparatus, comprising:
a slide hopper having a slide surface of which an inclining angle with respect to a horizontal plane is within a range between 5° and 30°, a plurality of coating liquids containing polyvinyl alcohol flowing down along the slide surface, the coating liquids being applied on a surface of a running web through a bead part formed between an end of the slide surface and the running web, a total thickness T [mm] of the coating liquids on the running web being smaller than a total thickness S [mm] of the coating liquids flowing down along the slide surface;
a backing roller which supports the running web, the backing roller being arranged with respect to the slide hopper to form a bead clearance CL [mm] between the end of the slide surface and the running web at the bead part satisfying an inequality (1),
T+0.05<CL<2T+0.1;
and
a pressure reduction device which reduces a bead back pressure P [mmH₂O] at a bottom of the bead part with respect to an atmospheric pressure satisfying an inequality (2),
2/CL+20<P<10/CL+20.

13. The slide-bead coating apparatus as defined in claim 12, wherein a density of polyvinyl alcohol contained in one of the coating liquids that forms a bottom layer among the layers is within a range between 0.5% and 5% by weight.

14. The slide-bead coating apparatus as defined in claim 13, wherein a viscosity of at least one of the coating liquids that forms one of the layers other than the bottom layer is higher than a viscosity of the one of the coating liquids that forms the bottom layer.

15. The slide-bead coating apparatus as defined in claim 12, wherein a coating speed that is a running speed of the running web is within a range between 100 m/min and 300 m/min.

16. The slide-bead coating apparatus as defined in claim 12, further comprising a surface treatment apparatus which applies surface treatment to the running web by one of corona treatment and electrification treatment before the surface of the running web is coated with the coating liquids.
